(19) United States
(12) Patent Application Publication
(10) Pub. No.: US 2012/0066222 A1
(43) Pub. Date: Mar. 15, 2012

(54) Web architecture for green design and construction

(76) Inventor: Tam T. Nguyen, Albuquerque, NM (US)

(21) Appl. No.: 12/807,803

(22) Filed: Sep. 14, 2010

(51) Int. Cl. G06F 17/30

(52) U.S. Cl. 707/737; 707/741; 707/769; 707/E17.002; 707/E17.005; 707/E17.014; 707/E17.089

(57) ABSTRACT

A method and computer programming 10 for web directory and search engine processing of a plurality of computation jobs in a grid computing system and hash function 12 used to speed up table look up or data comparison tasks, such as finding items in a database and detecting duplicated or similar records in a large file. The partitions 16, 18, 20, 22 decompose very large data in particular segment into smaller and more manageable pieces 24, 26, 28, 30. The system then retrieves specific data, produces information search results, and stores the information in a web directory or search database 32. Furthermore, the method using grid computing technologies and other computer programs for sharing computationally operations among organizations, sharing and managing data, and easy accessing the database. This present invention will eliminate the requirement of organizations of having supercomputers with many processors that linked together to achieve search results and is expensive to build and operate that is obsolete by emerging technologies. The method also enhances the value of searchers on time spent searching for specific information in particular segment of the design and construction industry.

### BACKGROUND OF THE INVENTION

1. Field of the Invention

The present invention relates to web architecture and methods for searching, collecting, retrieving, planning, organizing, developing, and communicating specific data that produces information system, indexed and stored information in a database and making desirable information available on the World Wide Web (“WWW”). More particularly, the invention relates to a method and computer program designed logistically for web directory or link directory, specializing in linking to specific web sites and/or information and categorizing those links in particular segment of an industry using grid-computing model, hash algorithms and partition tables to meet the needs of organizations in storing data and producing information.

2. Description of the Prior Art

Many organizations required searching for information at very high speed and less time. As the World Wide Web becomes bigger, the task of searcher is getting more complex and time consuming. This problem need to be improved to increase usability to satisfy user expectations which will primarily be used herein, is searching within sites contents to determine the classification of specific data and how it should be indexed for user to quickly retrieve information. There are basically two ways of searching for information in database systems: web directory and search engine. The present invention is intended to solve problems in search engine. A web directory organizes web sites by subjects, and usually maintained by human instead of software. Search engine on the other hand, is a complex entity. It is expensive for organizations to develop and operate, and it required a significant amount of time of the searcher when searching for information, and often the search results was not specific to the topics or subjects the searcher was looking for. Search engine is a software program designed to search for web sites base on the key words that you designated as search terms. Search engine then looks through their own databases for information in order to find what it is that searchers are looking for, and automatically creates web sites listing by using spider that “crawl” web pages, index their information and optimally follows that site's link to other pages. Spiders return to already-crawled sites on a regular basis in order to check for updates or changes, and everything that these spiders find goes into the search engine databases. Most web search engines are commercially driven by advertising revenue, and often employed the practice of allowing advertisers to pay money to have their listing ranked higher in search results. As a result, searchers constantly presented with over a million results. In addition to the current problem, there is an army of search engine optimization professionals whose primary goal is to raise the ranking of their web sites. There are two main types of search engine that have evolved: one is a system predefined and hierarchically encoded keywords that humans searched extensively, which is an obsolete system, the other is a system that generates an inverted index, also referred to as postings file by analyzing contents it locates. An inverted index is the most popular data structure used in document retrieval systems, storing a mapping from content, such as words or numbers to its location in a database file. This system is useful to use on a large scale in search engine but it needs a lot of more time and space to be created.

U.S. Pat. No. 6,917,934 describes a database search engine including a controller having a hash function able to receive an input search value and create hash addresses which are smaller than the input search value. A hash pointer unit stores pointer values, which are addressed base on the hash addresses. A memory stores a database of search results, wherein the respective search results are addressed base on said pointer values. An address bus connects the controller to the hash pointer units and communicates the hash addresses from the controller to the hash pointer unit. A pointer bus connects the hash pointer unit to the memory and communicates the pointer value from hash pointer unit to the memory. Finally, a result bus connects the memory to the controller and communicates the search results from the memory to the controller.

This method of using hash pointer function only solves one problem, which is to minimize collision to occur which is deficient with respect to the present needs of the green industry.

U.S. Patent Application Publication No. 20030217056 describes a method and computer program for collecting, rating, and making available information on the World Wide Web and other information sources, wherein the information is rated using a rating technique and filtered at least one based on one parameter identified by an end-user and one parameter identified by an intermediary. A more detail discloses a plurality of information relating to a particular subject, such as healthcare, for example, is first collected. The information is then manually rated by a trained rater who is an employee of an administrator of the computer program. Next the information is automatically rated using the rating technique, which assigns at least one value to each item of information, wherein the value represents a content of at least one administrator parameter within the item of information. The information is then indexed based on at least one unique keyword appearing to the information, such as for example, heart, obesity, diseases, etc. The administrator then may sell, license, or assign the method or computer program to a client-user such as a hospital, for example, that filter the rated information by applying at least one client-user parameter to the information. An end-user may further filter the rated information by applying at least one end-user parameter to the rated information.

This method not only complex but also too costly because of the computer equipment needed, which is a supercomputer system that have many processors linked together to produce search results and is expensive to build and operate. This method is out-dated and does not improve or simplify the process of retrieving specific information.

### SUMMARY OF THE INVENTION

The present invention is a collaboration of search engine and web directory architecture and methods of computer program used to develop to improve search engine and web directory or link directory, specializing in linking to specific web sites and/or information and categorizing those links in particular segment of the green architecture, design, and construction industry. Furthermore, the present invention using grid computing method that combines computer resources from multiple administrative domains to reach a common goal. Grid computing simultaneously applies the resources of many computers in a network to solve technical problems of accessing a large amount of data.

It is therefore a primary object of the present invention to provide collaboration services, and improved index database and search engine which will significantly enhance the value of searchers for specific data such as: solar, hybrid air conditioning, tankless hot water, water system, green technologies and service providers.

It is another object of the present invention that replace the interne by offering higher speeds than traditional broadband using many strategies of grid computing and other computer program to divide and apportion pieces of a program among computers that aggregate a large scale cluster computing-base systems.

It is a further object of the present invention of distributed computing for sharing computationally operations among organizations such as: managing, sharing, and accessing data. The advantage of this present invention is made up of resources which make processing power and disk storage available via the software running on the host computer which can be a laptop computer or a powerful computer in a server room.

It is still another object of the present invention providing such diverse application as forms of distributed computing system composed of many networked loosely coupled computers acting together to perform very large tasks such as back office data processing in support for electronic data interchange, web services, and green products discovery.

It is still a further object of the present invention to eliminate client's various processors needed and local storage areas that do not have high-speed connections by using parallel computing method that relies on complete computers system included: CPUs, storage, power supplies, network interfaces that connected to private, public, or the interne networks by a conventional network interfaces. The advantage of the present invention is substantial cost savings to clients over traditional notion of a supercomputer, which required many processors connected by a local high-speed computer bus.

These and other objects of the present invention, will become apparent to those skilled in this art upon reading the accompanying description, drawings, and claims set forth herein.

### BRIEF DESCRIPTION OF THE DRAWINGS

FIG. 1 is a flow diagram depicting a system that may be used to implement architecture and methods of computer program of the preferred embodiment of the web directory database and search engine database according to the present invention.

FIG. 2 is a flow diagram depicting a method of searching, creating, customizing folder(s), and stored information using the computer program of the present invention.

FIG. 3 is a flow diagram depicting a method of customizing, collecting, and storing desirable information using the computer program of the present invention.

FIG. 4 is a flow diagram depicting a method of searching, posting, and scheduling available via the interne calendar using the computer program of the present invention.

The drawing figures do not limit the present invention to the specific embodiment disclosed and described herein. The drawings are not necessary to scale, emphasis instead being place upon clearly illustrating the principles of the invention.

### DETAILED DESCRIPTION OF A PREFERRED EMBODIMENT OF THE INVENTION

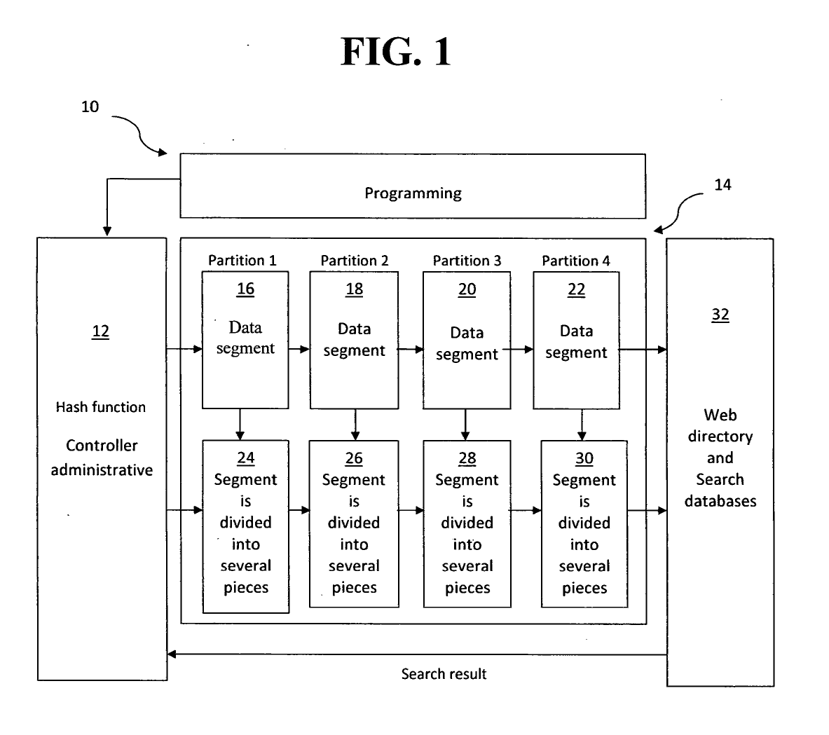

FIG. 1 shows a method of computer program system 10 for collecting, sorting, organizing, categorizing, and making specific information available on the web directory and search databases and other related information sources is shown and described constructed in accordance with the best mode contemplated by the inventor of the present invention. The hash function system 12 consists of a number of tables 14, 16, 18, 20, 22 organized to aid in quick retrieval for specific data. As can be amply seen from the drawings, the user types in specific term(s) or topic(s), the process involves creation of a large database that filters the queries and stores the data into categories consists of a number of partition tables 24, 26, 28, 30. The web directory and search database systems 32 then extracts the keywords or any related data needed and manually updating the queries. The administrator of the computer then analyses, modifies, and organizes the queries into specific categories. This present invention will cut back the user's time spent on searching for specific information where as current search engines work as a spider by storing information about many web pages through an automated web browser which follows every link on the web site.

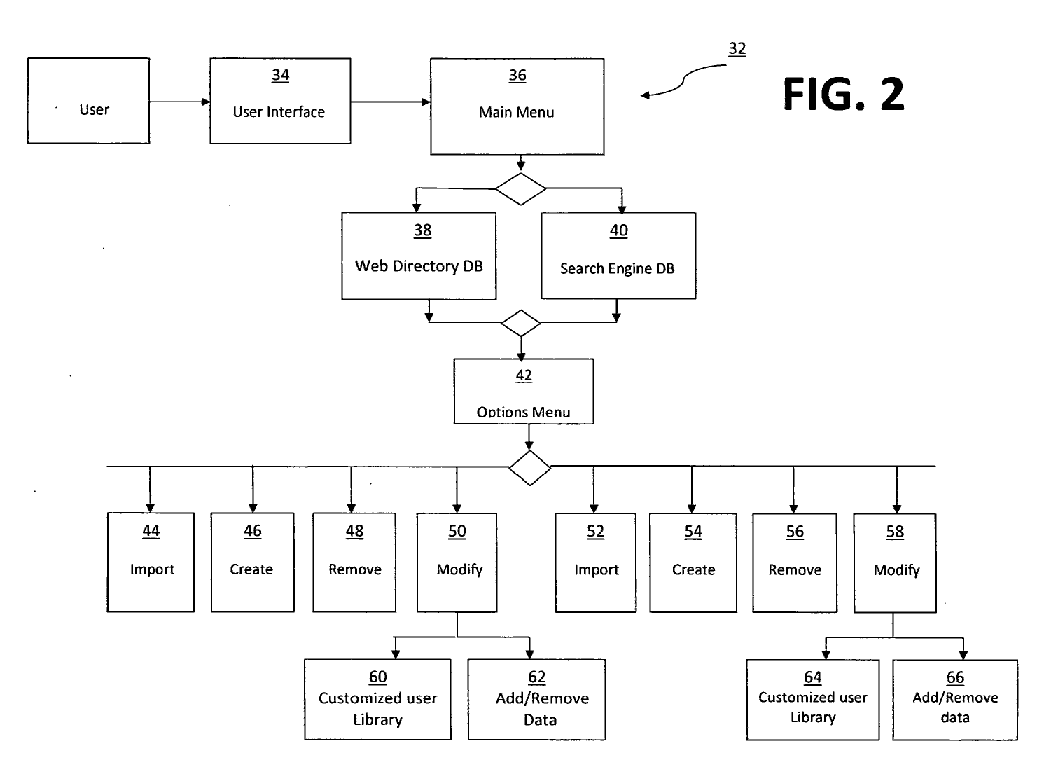

In the preferred embodiment of the present invention described herein, the method of searching, collecting, organizing, customizing, and storing information in specific folder is implemented using grid computing technologies, methods, and the computer programs comprising of one or more fully integrated source code modules and one or more files. The computer program is advantageously operable to select data from the WWW that is specifically tailored to meet the parameters selected by the administrator or SME subject matter expert who has special knowledge or skills in a specific area and the end user. FIG. 2 of the drawing shows a method and computer program 32 developed as a friendly user interface 34 that leads to operational main menu 36. The data is filtered by the computer program and analyzed by the administrator or SME, and stored into its location databases 38, 40, with the options 42 to choose either to import, create, remove, or modify 44, 46, 48, 50, 52, 54, 56, 58 the desired information and stored the information into the user's customized library 60, 64 for conveniently later use, or the user can add additional information or remove 62, 66 unwanted information. This preferred embodiment of the present invention will reduce the time spent necessary to peruse and select specific information from the multiplicity of information available on the WWW.

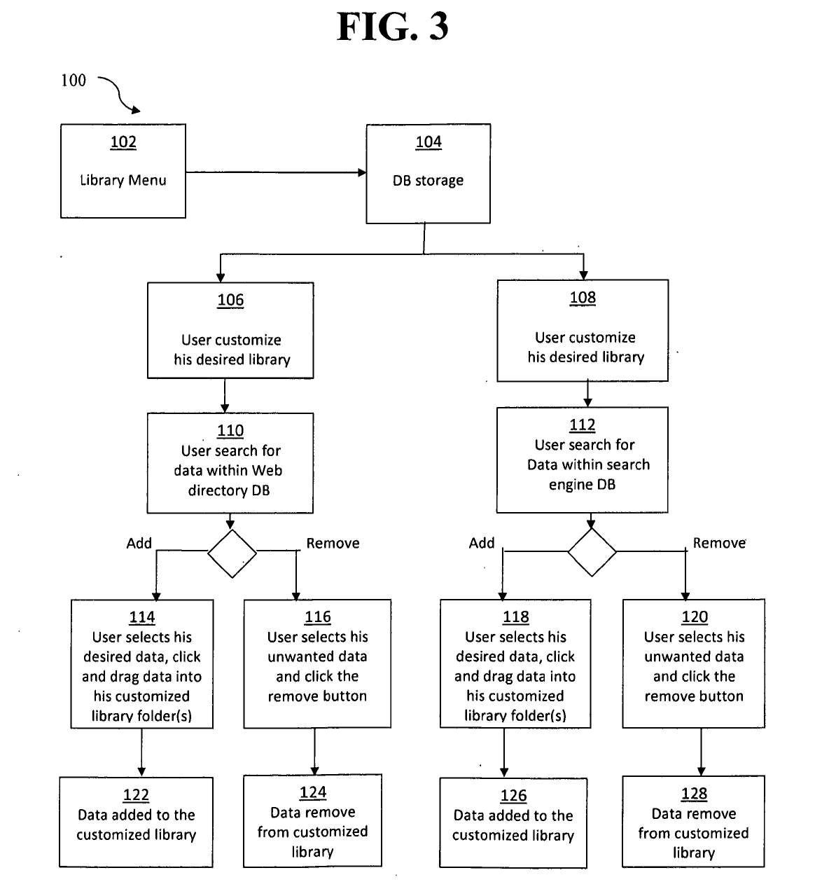

FIG. 3. The method and computer program system 100 of the present invention provides the user a library menu 102 from the database 104. The user customizes its library 106, 108 folder(s) with different categories within green design and construction, for example: solar energy, wall framing, green roof, green material etc., the user then searches for related information either in the web directory/search databases 110, 112 and when the user finds its desired information, the user can clicks and drags the information and drops it in a specified folder(s) 114, 118 that the user created and the information appeared in the customized library 122, 126 for later use or the user can removes 116, 120 unwanted information from the library and the unwanted information will be removed 124, 128 from the library. This allows for easy access to the information when needed and cut back significant amount of time spent on searching and tracking specific information from the databases.

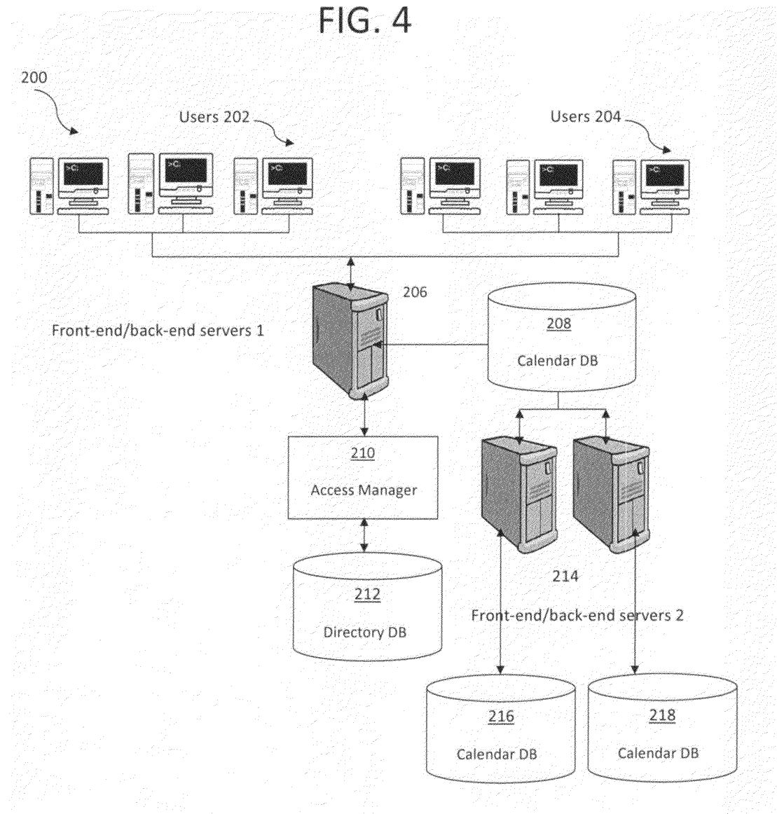

In the preferred embodiment of the present invention described herein, FIG. 4 of the drawing shows a centralized location model of master calendar architecture 200. The user 202, 204 accesses the calendar server 206 database 208, the access manager 210 oversees the overall calendar directory database 212 and performs day-to-day administrative tasks such as: coordinating events, group scheduling, approving or denying accessibilities of calendar databases 216, 218, and upgrading calendar servers 214 and making the information available electronically using the computer program comprising of one or more fully integrated source code modules and one or more files.

The value of the preferred embodiment of the present invention described herein, come by way of analogy with its non-technical meaning, to “chop and mix” the input domain into many sub-domains that get “mixed” into the output range to improve the uniformity of the key distribution. The methods and computer program for collecting, sorting, organizing, and indexed using variety programs are well defined procedure that converts a large variable sized amount of data into small datum, usually a single integer that may serves as an index to an array of segment of a particular industry. Furthermore, another advantage of this present invention is using hash tables to look up or data comparison tasks, such as finding specific data in the database, and detecting duplicated or similar records in a large file.

This preferred embodiment of the present invention designed using methods and computer program and multi-tiered grid architecture will include provisions qualitative analysis, content linking and associations, authentication and authorization, protected content environment, and content watermarking, hashing, partition, and encryption to effectively manage the networks databases.

The preferred embodiment of the present invention is designed to identify the intent of the user search and simplify the user search for specific information within a particular segment of an industry. Results provided are generally grouped in order of relevant segments that allow user to zero in on specific information. Search results are more comprehensive and more precise through friendly web interface. The user can easily finds information worldwide through millions of hours of video, directory, and zip code search. It is like using multiple search engines and indexes databases all at the same time.

The problems addressed by this present invention are many as can be easily seen by those skilled in this art. This improved web directory and search databases will cut back the user's time spent on searching for specific information and the avoidance of delivering hundreds of web pages from multiple search engines.

What is claimed is:

1. A method for improving a search engine and web directory databases system comprising the steps of:
collecting for information relating to a particular subject;
gathering additional information related to the requested information;
filtering the information related to a particular subject;
indexing the related information to a particular subject;
analyzing the information related to a particular subject by an administrator;
storing the information related to a particular subject in the assigned databases;
displaying the information related to a particular subject on the web; and
the computer program automated system updated the information on the databases.

2. The method as claimed in claim 1, wherein the collected data is filtered through an automated web browser and indexed in its location.

3. The method as claimed in claim 1, wherein the administrator analyzed the collected data for index accuracy.

4. The method as claimed in claim 1, wherein the computer program processed the queries, extracted and indexed categories in the database.

5. The method as claimed in claim 1, wherein the computer program functions “chop and mix” the input domain into many sub-domains that get “mixed” into the output range to improve the uniformity of the key distribution.

6. The method as claimed in claim 1, wherein the computer program function is well defined procedure that converts a large variable sized amount of data into small datum.

7. The method of searching, collecting, organizing, and customizing the information for later use queries by the user comprising the steps of:
searching for information relating to a particular subject;
collecting the desired information or related to the requested information;
creating the desired folder(s) to store the information related to a particular subject;
storing the information related to a particular subject in the folder(s) created.

8. The method as claimed in claim 7 wherein, the user customizes his library and creates the folder(s) to store the desired information.

9. The method as claimed in claim 7 wherein, the user types in the queries term(s) related to a particular subject.

10. The method as claimed in claim 7 wherein, the user interface displayed the requested information or related information to a particular subject.

11. The method as claimed in claim 7 wherein, the user chooses the desired information related to a particular subject, drags the information and drops it into the created folder(s) for later use.

12. The method of shared calendar, events coordination and providing group scheduling available electronically comprising the steps of:
collecting of information relating to a particular subject;
gathering additional information related to the requested information;
filtering the information related to a particular subject;
indexing the related information to a particular subject;
analyzing the information related to a particular subject by an administrator;
grouping the information related to a particular subject by an administrator;
storing the information related to a particular subject in the assigned architecture structure;
displaying the information related to a particular subject on the web calendar; and
the computer program automated system updated the information on the databases.

13. The method as claimed in claim 12 wherein, primary calendar owner or master calendar owner act on behalf of other calendar owners access to calendar properties and calendar components to schedule, delete, modify, accept, or decline events or todos tasks for a calendar.

14. The method as claimed in claim 12 wherein, the computer program specify the value for Access Control Entry (ACE) strings and how element specifies the type of access control rights permitted such as read, write, modify or delete.

15. The method as claimed in claim 12 wherein, the computer program grants element specifies whether to grant or deny specific access.

16. A web architecture system of claim 12, wherein web interface for assisting green design and construction comprising:
A computer system server;
A variety software programs;
Architecture methodologies;
Designing and planning of technical and functional criteria;
Networks databases among organizations;
Optimization of web content, usability, interaction design, information architecture how it relates to the WWW.
